(19) United States
(12) Patent Application Publication
(10) Pub. No.: US 2008/0023406 A1
(43) Pub. Date: Jan. 31, 2008

(54) Water filtration systems and methods

(75) Inventors: James Rulon Young Rawson, Clifton Park, NY (US); Shane Alan Gernand, Glenville, NY (US); Brian Christopher Moore, Rexford, NY (US)

Correspondence Address: JOHN S. BEULICK (13307), ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 11/638,007

(22) Filed: Dec. 13, 2006

Related U.S. Application Data
(60) Provisional application No. 60/834,237, filed on Jul. 28, 2006.

(51) Int. Cl. C02F 1/42

(52) U.S. Cl. 210/688; 210/282

(57) ABSTRACT

A pitcher filter cartridge for removing contaminants from water includes a housing defining a chamber. The housing further defines at least one inlet opening and at least one outlet opening. A first adsorption medium is contained within the chamber and configured to facilitate removing insoluble colloidal lead from the water.

### CROSS REFERENCE TO RELATED APPLICATIONS

This application claims the benefit of U.S. provisional application No. 60/834,237 filed Jul. 28, 2006, which is hereby incorporated by reference in its entirety.

### BACKGROUND OF THE INVENTION

This invention relates generally to water filtration systems and, more particularly, to water filtration systems configured to remove lead and other contaminants from water supplied by a water source.

In general, insoluble lead particles may be removed by mechanical filtration methods provided the filter has pores small enough to exclude the insoluble lead particles. Separation efficiency is increased with filters containing smaller pore sizes, although higher pressures are needed to maintain flow through the filter. In the case of residential water purification, however, the mechanical filtration of insoluble lead cannot be done at pressures higher than those existing at the building point of entry (POE), typically 60 psi. Moreover, in some point of use (POU) lead filters, such as pitcher filters, there is no pressure driving force through the filter except for gravity, and so high efficiency mechanical filtration methods are not suitable for such application. Alternative practical solutions to the removal of insoluble lead are needed in residential water applications.

As much as about 40% to about 60% of the lead in drinking water may be insoluble and exist as colloidal or particulate matter. This colloidal lead exists as particles in the micron and sub-micron size. Lead is often released into drinking water distribution systems from municipal distribution lead pipes, brass fixtures and/or lead-based solders. The U.S. Environmental Protection Agency (USEPA) has set the action level for lead in drinking water at 15 micrograms/L (μg/L). When drinking water systems are devoid of materials that contain lead, this concentration of lead can be easily achieved. However, when lead is present in a drinking water distribution system, the total concentration of lead in the drinking water can often exceed the USEPA action level for lead. Further, the USEPA has also lowered the maximum concentration level (MCL) for arsenic in drinking water from 50 μg/L to 10 μg/L. Therefore, many of the sources of drinking water previously identified as safe now require further purification to assure the water meets the USEPA safe drinking water requirements.

Consumers may use a POU filter, such as a POU stand-alone pitcher, to facilitate removal of a sufficient amount of lead and arsenic from the drinking water to meet the USEPA action level and MCL, respectively, for these contaminants. However, in the past, it was generally not recognized that a substantial quantity of insoluble colloidal lead had to be removed from drinking water to meet the USEPA action level for lead. Therefore, POU filters configured to remove lead must now be capable of removing both insoluble colloidal lead and soluble lead from residential drinking water. Further, POU filters configured to remove both soluble and insoluble lead present in drinking water should also be capable of removing arsenic.

### BRIEF DESCRIPTION OF THE INVENTION

In one aspect, a pitcher filter cartridge for removing contaminants from water is provided. The pitcher filter includes a housing defining a chamber, at least one inlet opening and at least one outlet opening. A first adsorption medium is contained within the chamber and configured to facilitate removing insoluble colloidal lead from the water.

In a further aspect, a water filtration system for removing contaminants from water is provided. The water filtration system includes a filter cartridge configured to receive unfiltered water. The filter cartridge includes a housing defining a chamber, at least one inlet opening through a top portion of the housing and at least one outlet opening through a bottom portion of the housing. At least one adsorption medium is contained within the chamber. The at least one adsorption medium is configured to adsorb insoluble colloidal lead to facilitate removing insoluble colloidal lead from the water.

In a further aspect, a method is provided for removing contaminants from water. The method includes operatively coupling a filter cartridge to a reservoir configured to supply water to the filter cartridge. The filter cartridge includes a housing defining a chamber, at least one inlet opening through a top portion of the housing and at least one outlet opening through a bottom portion of the housing. The filter cartridge also includes a negatively charged adsorption medium and a positively charged adsorption medium contained within the chamber. The water is directed to flow into the chamber through the at least one inlet opening. Positively charged soluble lead is adsorbed onto the negatively charged adsorption medium as the water flows through the chamber to facilitate removing soluble lead from the water. Negatively charged insoluble colloidal lead is adsorbed onto the positively charged adsorption medium as the water flows through the chamber to facilitate removing negatively charged insoluble lead from the water.

### BRIEF DESCRIPTION OF THE DRAWINGS

FIG. 1 is a schematic side view of an exemplary filter cartridge.

FIG. 2 is a schematic top view of the filter cartridge shown in FIG. 1.

FIG. 3 is a schematic bottom view of the filter cartridge shown in FIG. 1.

### DETAILED DESCRIPTION OF THE INVENTION

The present invention provides a system and method for removing both soluble lead and insoluble lead and other contaminants from water supplied by a water source to provide filtered water suitable for consumption. By directing the source water through a pitcher filter cartridge, soluble lead and insoluble colloidal or particulate lead, as well as other undesirable contaminants including, without limitation, arsenic, chlorine, taste and/or odors, are removed from the source water to provide filtered water suitable for consumption. The source water enters the filter cartridge through a plurality of inlet openings defined through a top portion of the filter cartridge, such as through a top surface and/or sidewall of the filter cartridge, and exits the filter cartridge through a bottom portion of the filter cartridge, such as through a plurality of outlet openings defined through a bottom surface of the filter cartridge housing.

The present invention is described below in reference to its application in connection with and operation of a pitcher filter. However, it should be apparent to those skilled in the art and guided by the teachings herein provided that the invention is likewise applicable to any point of use water filtration system including, without limitation, residential and/or industrial point of use water filtration systems.

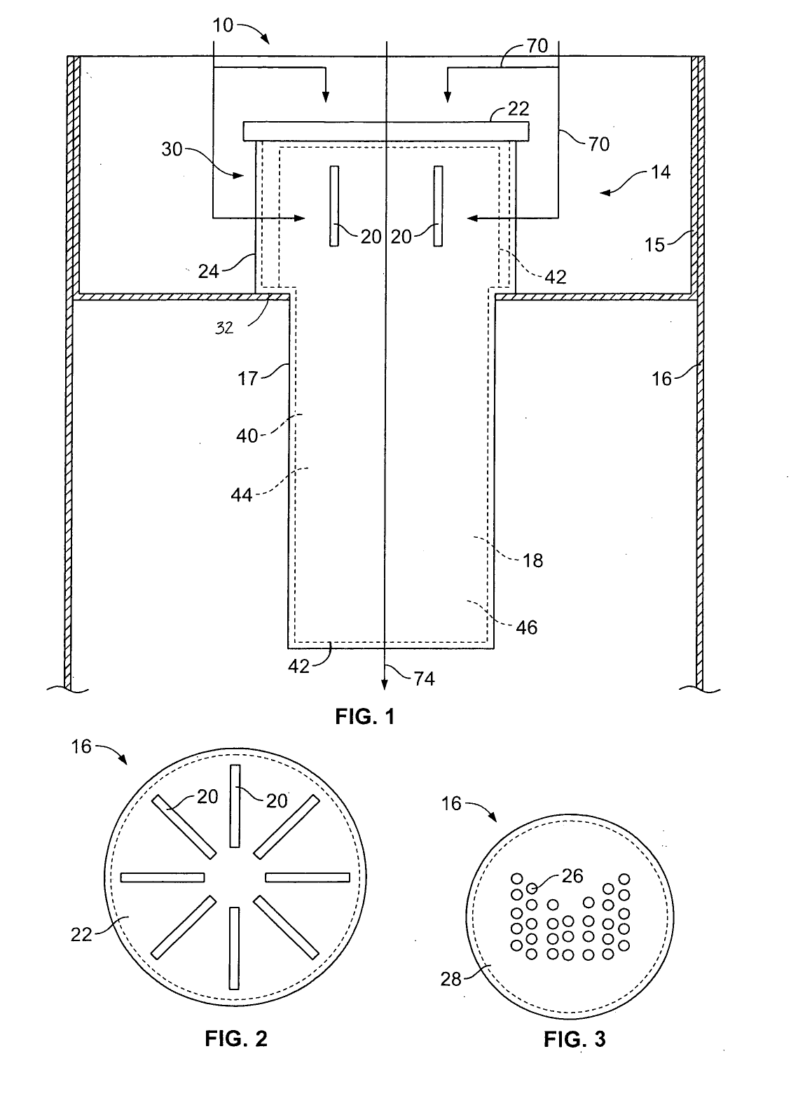

Referring to FIGS. 1-3, in one embodiment a water filtration system 10 for removing soluble and insoluble lead and other contaminants including, without limitation, arsenic (V) in the form of H₂AsO₄⁻, chlorine, taste and/or odors, from water supplied by a water source (not shown) includes a filter cartridge 14. Filter cartridge 14 is positioned within an opening defined through a reservoir 15, which is supported at a top portion of a pitcher 16 or other suitable container. Filter cartridge 14 extends into pitcher 16 to provide fluid communication between reservoir 15 and pitcher 16 to facilitate flow of water from reservoir 15 into pitcher 16. Filter cartridge 14 facilitates removal of contaminants, such as soluble and insoluble lead and arsenic, from the source water as the source water flows through filter cartridge 14 to provide filtered water suitable for user consumption. In one embodiment, source water is poured into reservoir 15, which is positioned on top of pitcher 16. Water flows from reservoir 15 through filter cartridge 14 and into pitcher 16. As water flows through filter cartridge 14, adsorption media contained within filter cartridge 14 remove contaminants, such as soluble and insoluble lead and arsenic, as described below. Filtered water is contained within pitcher 16 and can be dispensed from pitcher 16, as desired.

In one embodiment, filter cartridge 14 includes a housing 17 that defines a chamber 18, as shown in FIG. 1. In the exemplary embodiment, housing 17 is molded of a suitable plastic material. It should be apparent to those skilled in the art and guided by the teachings herein provided that any suitable material may be used to form housing 17.

Housing 17 further defines at least one inlet opening 20 through a top portion of housing 17. Referring to FIGS. 1 and 2, in the exemplary embodiment, a plurality of inlet openings 20 are defined through a top surface 22 and/or a sidewall 24 of housing 17. Further, at least one outlet opening 26 is defined through a bottom portion of housing 17. As shown in FIG. 3, a plurality of outlet openings 26 are defined through a bottom surface 28 of housing 17. Referring further to FIGS. 1-3, in the,exemplary embodiment, housing 17 includes a cap 30 that is integrated with or coupled to housing 17, such as to sidewall 24, and is configured to enclose chamber 18. Housing 17 and/or cap 30 defines at least one inlet opening 20 through sidewall 24, as shown in FIG. 1, and/or at least one inlet opening 20 through top surface 22 of cap 30, as shown in FIG. 2. Further, housing 17 and/or cap 30 form a lip or edge 32 that interferes with reservoir 15 to retain filter cartridge 14 properly positioned within reservoir 15.

Chamber 18 has suitable dimensions to define a volume configured to contain a filter 40, such as at least one adsorption medium configured to adsorb total lead, including soluble lead and insoluble colloidal lead, as well as other contaminants including, without limitation, arsenic, taste and/or odors, from the source water. In the exemplary embodiment, filter 40 includes adsorption media suitable to facilitate removing and adsorbing contaminants from the source water. In one embodiment, filter 40 includes granular adsorption media that are contained within a screen material 42 positioned within chamber 18. Screen material 42 is configured to contain the adsorption medium or media within chamber 18.

In the exemplary embodiment, a plurality of adsorption media are contained within housing 17. In this embodiment, a first adsorption medium 44 is contained within housing 17 and configured to facilitate removing insoluble colloidal lead from the source water and a second adsorption medium 46 is contained within housing 17 and configured to facilitate removing soluble lead from the source water.

First adsorption medium 44 is negatively charged to attract the positively charged soluble lead to facilitate removing positively charged soluble lead. In a particular embodiment, negatively charged adsorption medium 44 includes an inorganic adsorption medium, such as an ATS ceramic cation adsorption medium including titanium silicate manufactured by BASF/Engelhard and/or any suitable media having a negative Zeta potential capable of removing and adsorbing positively charged soluble lead from the influent water, such as a weak cation exchange resin. Negatively charged adsorption medium 44 removes soluble lead by electrostatic charge adsorption of positively charged soluble lead.

Additionally, second adsorption medium 46 is positively charged to facilitate removing negatively charged insoluble colloidal lead from the source water. The removal of negatively charged insoluble colloidal lead is facilitated with the use of a positively charged medium that attracts the negatively charged insoluble colloidal lead and removes the negatively charged insoluble colloidal lead from the source water.

Most insoluble colloids in water develop a surface charge that causes the insoluble colloids to repel one another and remain suspended in the water. These electrostatic charges are responsible for charge related phenomena in colloidal systems, such as flocculation and dispersion stability of dilute and concentrated suspensions. At a high pH, colloids are typically negatively charged, while at a lower pH colloids are often positively charged. The pH at which colloids are neutrally charged or where the charge on colloids changes from positive to negative is referred to as the isoelectric point (EEP), or the point of zero charge. The isoelectric point for different inorganic colloids can vary widely as a function of the different types of colloidal materials. For instance, the isoelectric point of silica is at a pH of about 2 to about 3, while that of activated alumina particles is at a pH of about 8 to about 9. Therefore, depending on the charge or the Zeta potential (negative or positive mV) of the inorganic colloidal materials within the source water, either a positively charged medium or a negatively charged medium is utilized to adsorb the charged insoluble colloidal materials.

In this embodiment, positively charged adsorption medium 46 is contained within housing 17 and configured to remove the insoluble colloidal lead by taking advantage of a negative electrostatic charge present on the insoluble colloidal lead suspended in the source water. At the pH found in drinking water, such as a pH of about 6.5 to about 8.5, insoluble colloidal lead is negatively charged. In a pH range of about 6.5 to about 8.5, a measured Zeta potential or charge of colloidal lead is typically in the range of −19 mV to −17 mV, respectively. Therefore, the isoelectric point (IEP) of the colloidal lead is less than 6.5, which is the lower limit for the pH of drinking water.

The aforementioned characterization of the insoluble colloidal lead indicates that a medium that is positively charged will attract the negatively charged insoluble colloidal lead and remove the negatively charged insoluble colloidal lead from the drinking water. Suitable types of materials for enhancing the electrostatic interactions with insoluble colloidal lead include, without limitation, activated alumina having an IEP of about 8.5 to about 9.1. A suitable material for positively charged adsorption medium 46 may depend upon various parameters including, without limitation, the charge of the lead particles at the pH of the water from which the lead particles are to be removed.

In the exemplary embodiment, positively charged adsorption medium 46 includes an inorganic adsorption medium, such as an activated alumina medium and/or any suitable medium having a positive Zeta potential capable of removing and adsorbing negatively charged insoluble lead from the influent water. In a particular embodiment, positively charged adsorption medium 46 includes activated alumina including crystalline boehmite (AlO(OH)). Positively charged adsorption medium 46 removes insoluble lead by electrostatic charge adsorption of negatively charged insoluble lead.

Positively charged adsorption medium 46 contained within filter cartridge 14 is configured to remove the insoluble colloidal lead by taking advantage of a negative electrostatic charge present on the insoluble colloidal lead suspended in the source water, as described above. Further, positively charged adsorption medium 46 is also configured to facilitate removing negatively charged arsenic (V) in the form of H₂AsO₄⁻. In alternative embodiments, positively charged adsorption medium 46 includes an any suitable medium known to those skilled in the art and guided by the teachings herein provided that facilitates adsorbing and/or removing undesirable negatively charged contaminants from the source water.

In a further exemplary embodiment, granular activated carbon (GAC) is contained within chamber 18. GAC is configured to facilitate removing chlorine, taste and/or odor from the source water as the source water is filtered through filter cartridge 14.

Referring further to FIG. 1, in one embodiment a method for removing total lead, including soluble lead and insoluble colloidal lead, from water supplied by a water source is provided. Influent flow of water 70 flows from reservoir 15 through openings 20 defined within top surface 22 and/or side wall 24 of filter cartridge 14. As influent flow of water 70 is filtered through filter cartridge 14, positively charged soluble lead is removed from the source water and adsorbed onto negatively charged adsorption medium 44 and negatively charged insoluble colloidal lead is removed from the source water and adsorb onto positively charged adsorption medium 46. Influent flow of water 70 flows from reservoir 15 through the top portion of filter cartridge 14 and an effluent flow of filtered water 74 exits filter cartridge 14 through outlet openings 26 as filtered water suitable for user consumption, as desired.

In an alternative embodiment, a bifunctional lead adsorption medium (not shown) capable of removing soluble lead and insoluble lead is positioned within chamber 18. In a particular embodiment, the bifunctional lead adsorption medium includes both a negatively charged adsorption medium and a positively charged adsorption medium, which facilitate removing soluble lead and insoluble colloidal lead, respectively, from the influent water.

In one embodiment, soluble and insoluble colloidal lead is removed predominantly due to charge adsorption of the variously charged lead species to the adsorption media. The presence of both negatively charged and positively charged adsorption media facilitates removing lead, whether positively charged or negatively charged and/or soluble or insoluble, from the influent water.

The above-described systems and methods for removing soluble and insoluble lead and other contaminants from water supplied by a water source providing filtered water suitable for user consumption. More specifically, by directing the source water from the reservoir through a pitcher filter cartridge, soluble lead and insoluble colloidal or particulate lead, as well as other undesirable contaminants, are removed from the source water. As a result, potable filtered water can be reliably and efficiently collected into the pitcher.

Exemplary embodiments of systems and methods for providing filtered water suitable for user consumption are described above in detail. The systems and methods are not limited to the specific embodiments described herein, but rather, components of the system and/or steps of the method may be utilized independently and separately from other components and/or steps described herein. Further, the described system components and/or method steps can also be defined in, or used in combination with, other systems and/or methods, and are not limited to practice with only the systems and methods as described herein.

While the invention has been described in terms of various specific embodiments, those skilled in the art will recognize that the invention can be practiced with modification within the spirit and scope of the claims.

What is claimed is:

1. A pitcher filter cartridge for removing contaminants from water, said pitcher filter cartridge comprising:
a housing defining a chamber, said housing further defining at least one inlet opening and at least one outlet opening; and
a first adsorption medium contained within said chamber and configured to facilitate removing insoluble colloidal lead from the water.

2. A pitcher filter cartridge in accordance with claim 1 wherein said first adsorption medium comprises a positively charged adsorption medium configured to facilitate removing negatively charged insoluble colloidal lead from the water.

3. A pitcher filter cartridge in accordance with claim 2 wherein said positively charged adsorption medium is configured to facilitate removing negatively charged arsenic from the water.

4. A pitcher filter cartridge in accordance with claim 2 wherein said positively charged adsorption medium further comprises activated alumina.

5. A pitcher filter cartridge in accordance with claim 4 wherein said activated alumina further comprises crystalline boehmite.

6. A pitcher filter cartridge in accordance with claim 1 further comprising a second adsorption medium contained within said chamber, said second adsorption medium comprising a negatively charged adsorption medium configured to facilitate removing positively charged soluble lead.

7. A pitcher filter cartridge in accordance with claim 1 further comprising granular activated carbon contained within said chamber, said granular activated carbon configured to facilitate removing at least one of chlorine, taste and odor from the water.

8. A pitcher filter cartridge in accordance with claim 1 wherein said at least one inlet opening is defined within a top portion of said housing and said at least one outlet opening is defined within a bottom portion of said housing.

9. A pitcher filter cartridge in accordance with claim 1 wherein said housing further comprises a cap coupled to said housing, said cap defining a plurality of inlet openings and configured to enclose said chamber.

10. A pitcher filter assembly for removing contaminants from water, said pitcher filter assembly comprising:
a pitcher filter cartridge configured to receive unfiltered water, said filter cartridge comprising:
a housing defining a chamber, at least one inlet opening through a top portion of said housing and at least one outlet opening through a bottom portion of said housing; and
at least one adsorption medium contained within said chamber, said at least one adsorption medium configured to adsorb insoluble colloidal lead to facilitate removing insoluble colloidal lead from the water.

11. A pitcher filter assembly in accordance with claim 10 wherein said at least one adsorption medium is configured to adsorb soluble lead to facilitate removing soluble lead from the water.

12. A pitcher filter assembly in accordance with claim 10 wherein said at least one adsorption medium comprises a positively charged adsorption medium configured to facilitate removing negatively charged insoluble colloidal lead from the water.

13. A pitcher filter assembly in accordance with claim 12 wherein said positively charged adsorption medium is configured to facilitate removing negatively charged arsenic from the water.

14. A pitcher filter assembly in accordance with claim 12 wherein said positively charged adsorption medium further comprises activated alumina.

15. A pitcher filter assembly in accordance with claim 12 wherein said at least one adsorption medium comprises a negatively charged adsorption medium configured to facilitate removing positively charged soluble lead.

16. A pitcher filter assembly in accordance with claim 10 further comprising granular activated carbon contained within said chamber, said granular activated carbon configured to facilitate removing at least one of chlorine, taste and odor from the water.

17. A method for removing contaminants from water, said method comprising:
operatively coupling a filter cartridge to a reservoir configured to supply water to the filter cartridge, the filter cartridge comprising a housing defining a chamber, at least one inlet opening through a top portion of the housing and at least one outlet opening through a bottom portion of the housing, and a negatively charged adsorption medium and a positively charged adsorption medium contained within the chamber;
directing the water to flow into the chamber through the at least one inlet opening;
adsorbing positively charged soluble lead onto the negatively charged adsorption medium as the water flows through the chamber to facilitate removing soluble lead from the water; and
adsorbing negatively charged insoluble colloidal lead onto the positively charged adsorption medium as the water flows through the chamber to facilitate removing negatively charged insoluble lead from the water.

18. A method in accordance with claim 17 further comprising directing filtered water to exit the chamber through the at least one outlet opening.

19. A method in accordance with claim 17 further comprising removing negatively charged arsenic as the water flows through the chamber.

20. A method in accordance with claim 17 further comprising positioning granular activated carbon within the chamber to facilitate removing at, least one of chlorine, taste and odor.
